(19) United States
(12) Patent Application Publication
(10) Pub. No.: US 2016/0105320 A1
(43) Pub. Date: Apr. 14, 2016

(54) AUTOMATED NETWORK CONFIGURATION IN A CLOSED NETWORK TOPOLOGY

(71) Applicant: CISCO TECHNOLOGY, INC., San Jose, CA (US)

(72) Inventors: Roy Edward Osterberg, Clearlake, CA (US); Theodore Grevers, JR., Milford, MA (US); Jason Greengrass, Cary, NC (US)

(73) Assignee: CISCO TECHNOLOGY, INC., San Jose, CA (US)

(21) Appl. No.: 14/513,634

(22) Filed: Oct. 14, 2014

(51) Int. Cl. H04L 12/24; H04L 29/08

(52) U.S. Cl. CPC H04L 41/0853; H04L 41/082; H04L 67/125

(57) ABSTRACT

In one embodiment, a method includes discovering at a master network device, a plurality of slave network devices and locations of the slave network devices in a closed network topology, storing at the master network device, a location, address, and status for each of the slave network devices, synchronizing the status of each of the slave network devices at the master network device, and transmitting from the master network device, a configuration for application at each of the slave network devices. An apparatus and logic are also disclosed herein.

### TECHNICAL FIELD

The present disclosure relates generally to communication networks, and more particularly, to automated network configuration.

### BACKGROUND

Industrial network architectures are often based on designs with network devices interconnected in a preplanned format and used in environments such as factories, oil wells, or coal mines (referred to herein as a Plant) that have minimal training of plant operators in the use and configuration of the network devices. Operations such as replacing flash memory modules in devices may be risky, since the module may be corrupted, damaged, or simply missing, or may no longer be feasible in environments with sealed devices, which do not support removable modules. Maintenance personnel should therefore be able to install or replace network devices with little technical expertise.

### BRIEF DESCRIPTION OF THE DRAWINGS

FIGS. 1A, 1B, and 1C illustrate examples of networks in which embodiments described herein may be implemented.

FIG. 2 depicts an example of a network device useful in implementing embodiments described herein.

FIG. 3 is a flowchart illustrating an overview of a process for automated network configuration, in accordance with one embodiment.

FIG. 4 illustrates a new installation discovery, in accordance with one embodiment.

FIG. 5 illustrates synchronization between master and slave devices, in accordance with one embodiment.

FIG. 6 illustrates distribution of configurations, in accordance with one embodiment.

FIG. 7 illustrates power outage recovery, in accordance with one embodiment.

FIG. 8 illustrates a slave configuration change made on the master device, in accordance with one embodiment.

FIG. 9 illustrates a configuration change made directly on the slave device, in accordance with one embodiment.

FIG. 10 illustrates replacement of the slave device, in accordance with one embodiment.

FIG. 11 illustrates replacement of the master device, in accordance with one embodiment.

FIG. 12 illustrates replacement of the master device without a topology configuration at the new master device, in accordance with one embodiment.

FIG. 13 illustrates detection of a rogue network device, in accordance with one embodiment.

FIG. 14 illustrates addition of a new slave device, in accordance with one embodiment.

Corresponding reference characters indicate corresponding parts throughout the several views of the drawings.

### DESCRIPTION OF EXAMPLE EMBODIMENTS

### Overview

In one embodiment, a method generally comprises discovering at a master network device, a plurality of slave network devices and locations of the slave network devices in a closed network topology, storing at the master network device, a location, address, and status for each of the slave network devices, synchronizing the status of each of the slave network devices at the master network device, and transmitting from the master network device, a configuration for application at each of the slave network devices.

In another embodiment, an apparatus generally comprises a processor for processing a packet received from a master network device at a slave network device in a closed network topology comprising a plurality of slave network devices, transmitting a return packet to the master network device, the return packet comprising a location of the slave network device in the closed network topology, receiving a configuration from the master network device, and applying the configuration at the slave network device. The apparatus further comprises memory for storing the configuration.

### Example Embodiments

The following description is presented to enable one of ordinary skill in the art to make and use the embodiments. Descriptions of specific embodiments and applications are provided only as examples, and various modifications will be readily apparent to those skilled in the art. The general principles described herein may be applied to other applications without departing from the scope of the embodiments. Thus, the embodiments are not to be limited to those shown, but are to be accorded the widest scope consistent with the principles and features described herein. For purpose of clarity, details relating to technical material that is known in the technical fields related to the embodiments have not been described in detail.

As industrial environments continue to evolve, many network users are looking for ways to improve Plant performance while reducing costs, downtime, and configuration errors. Simplified configuration of network devices for installation, management, and rapid replacement and recovery is therefore important in an industrial environment.

The embodiments described herein provide for dynamic maintenance of a network infrastructure without the need for a centralized management system. This allows for a unique grouping of network devices into logical mappings based on relative location to a master device, regardless of network topology. Certain embodiments provide for ease of use, installation, repair, recovery, and software distribution often needed in the industrial network environment.

As described in detail below, a master-slave relationship is used within the network topology. Initial system configuration may take place on the master device once a slave device is connected to a port on the master. The slave may request its configuration from the master based on the corresponding master device port, for example. When a slave within the network is replaced, the slave may request a new configuration from the master device, thereby reducing the possibility of a configuration error during installation. Certain embodiments may eliminate the need for a removable flash memory module, and in the case of a sealed unit device, the need for local programming of the device may also be eliminated.

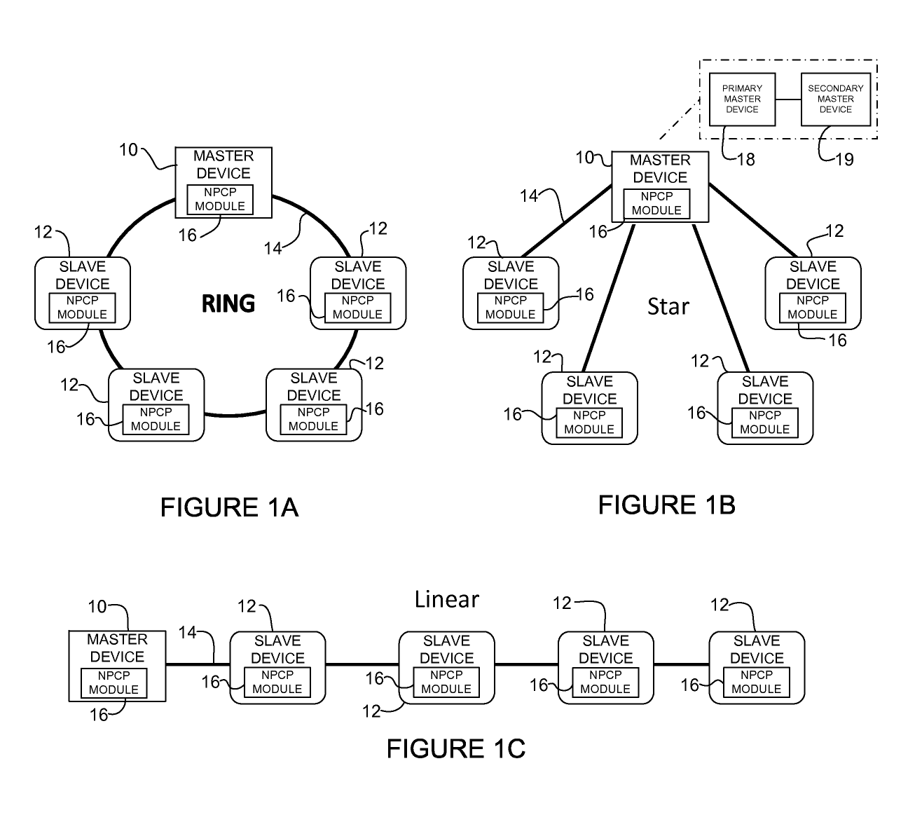

Referring now to the drawings, and first to FIGS. 1A, 1B, and 1C, examples of networks in which embodiments described herein may be implemented are shown. The embodiments operate in the context of a data communications network including multiple network devices (nodes). Some of the devices in the network may be switches, routers, servers, or other network devices. For simplification, only a limited number of network devices and network topologies are shown. In the examples shown in FIGS. 1A, 1B, and 1C, a plurality of network devices 10, 12 are in communication via network links 14. Each network includes at least one master device (master, master network device) 10 and any number of slave devices (slaves, slave network devices) 12. The network devices 10, 12 may be arranged, for example, in a ring topology (FIG. 1A), with ports on the master device connected to the ring, and ring position related to connected ports. As shown in FIG. 1B, the network devices 10, 12 may also be arranged in a star topology, with direct port connection to the master device. The network devices 10, 12 may also be configured in a linear topology, as shown in FIG. 1C.

Referring again to FIG. 1B, the star network topology may also include a backup (secondary) master device to provide network redundancy (shown in phantom in FIG. 1B). In addition to the direct port connection to a primary master device 18, a second direct port connection is provided on a secondary master device 19. The backup master 19 may request slave configurations from the primary master 18, for example. A redundant master configuration may also be used in other network topologies.

Each of the networks shown in FIGS. 1A, 1B, and 1C is a closed network topology. The term ‘closed network’ as used herein refers to a self-contained network comprising a group of network devices that communicate among themselves without accessing another network or network device for management support, network control, or maintenance. The closed network may operate, for example, in an industrial application. In one example, the closed network comprises industrial Ethernet access switches.

As shown in FIGS. 1A-1C, each of the network devices 10, 12 comprises an NPCP (Network Position Control Protocol) module 16. The NPCP module 16 may provide, for example, operational support in multiple topologies simultaneously and support a redundant configuration in all topologies. NPCP is preferably enabled on each network device, which is identified as a primary master, backup master, or slave device. In one embodiment, the default setting for the network device is slave, since the majority of the network devices are slaves.

In one embodiment, NPCP is enabled at the port level on uplink ports designated as NPCP ports. NPCP may be manually enabled on all other ports (e.g., downlink ports). In the example shown in FIG. 1A, NPCP is enabled on a port on the master device 10 that is connected to the ring. The blocked port in the ring topology is a secondary port on the primary master device 10 or secondary port on a backup master device. For a star topology (FIG. 1B), the port connection on the master device 10 refers to a single device connection (no daisy chained devices behind the slave device 12). This adds a point of security by denying access to a switch that might be attached to a slave device in this topology. For a linear topology (FIG. 1C), the port connection on the master device 10 has multiple devices connected in a single run.

It is to be understood that NPCP is used herein as an example of a protocol that may be used to implement embodiments described herein. The term NPCP (or network position control protocol) as used herein may refer to any protocol or mechanism that provides position detection as described herein.

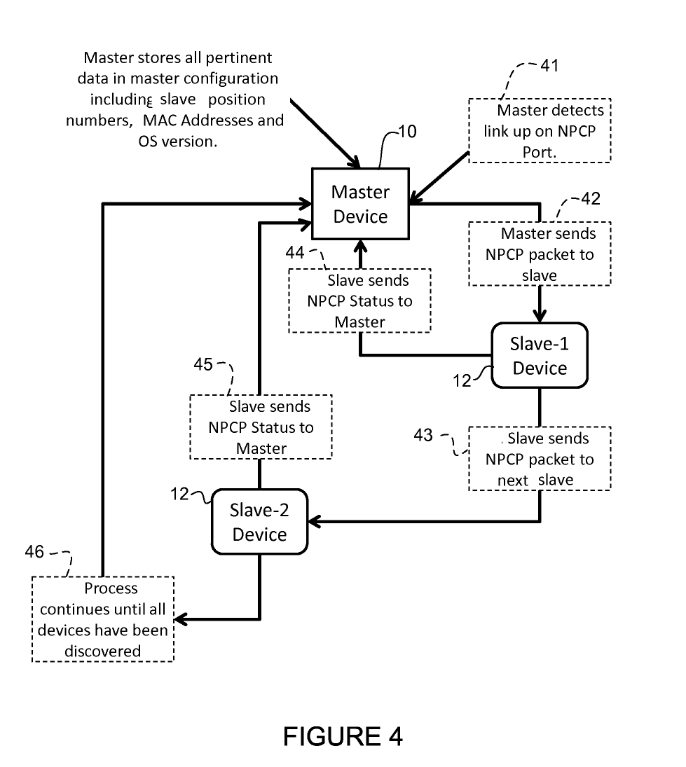

As noted above, the master-slave relationship is used to maintain network infrastructure without the need for a centralized management system. The following describes an overview of the master-slave functions and relationships, in accordance with one embodiment. Details of the master-slave functions are described further below with respect to the examples shown in FIGS. 4-14.

The master device 10 may provide a configuration to each of the slave devices 12 for application at the slave device and maintain a complete inventory of all slave devices in the closed network topology. The slave devices 12 may each maintain a table identifying immediate upstream and downstream neighbors. In certain embodiments, the master 10 ensures that all slave devices 12 under its control are operating with the same version of operating system (OS). If the operating system installed at the slave device 12 does not match the operating system installed at the master device 10, the slave device may request the correct version of the operating system (or an update to the operating system) from the master device prior to performing a configuration process (described below).

The slave device 12 may request a configuration from the master device 10 after boot. For a power cycle, the slave device 12 may reboot and load a local configuration file, and then validate the configuration file with the master device 10. If there is a difference in files based upon a hash exchange, for example, the slave 12 may request a new configuration file from the master 10.

As described below, changes may be made at the master device 10 or directly on the slave device 12. When changes are made to configuration on the slave, the slave transmits a new configuration file to the master 10 to save as a replacement configuration file.

In one embodiment, the slave devices 12 may continually (e.g., periodically) generate messages (e.g., NPCP topology health messages) and transmit the messages to the master device 10. This allows the master device 10 to continually monitor and maintain topology accuracy and security. The slave device 12 may transmit a message (e.g., NPCP topology change message) to the master 10 if there is a transition of NPCP ports. The master device 10 may rerun a discovery process when an NPCP topology change message is received to validate NPCP topology.

It is to be understood that the networks shown in FIGS. 1A, 1B, and 1C and described above are only examples and that the embodiments described herein may be implemented in networks having different network topologies and network devices, without departing from the scope of the embodiments.

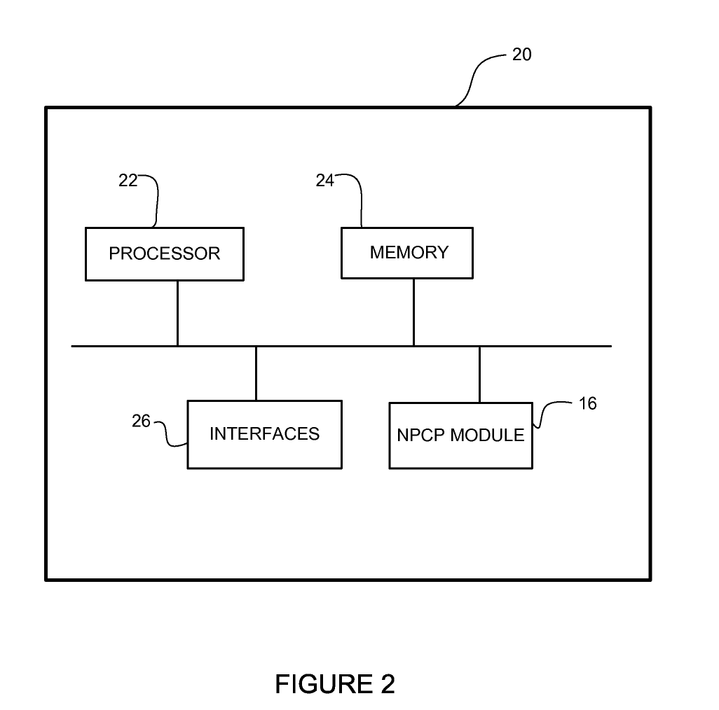

FIG. 2 is a block diagram illustrating an example of a network device 20 (e.g., master network device 10, slave network device 12) that may be used to implement embodiments described herein. The network device 20 is a programmable machine that may be implemented in hardware, software, or any combination thereof. The network device 20 includes a processor 22, memory 24, interfaces 26, and NPCP module 16.

Memory 24 may be a volatile memory or non-volatile storage, which stores various applications, modules, and data for execution and use by the processor 22.

The NPCP module 16 may be embedded in the network device through the use of software or hardware, or any mechanism operable to perform the functions described herein. For example, the NPCP module 16 may comprise logic and data structures (e.g., NPCP table, configuration table) stored in memory 24. The NPCP module 16 may include an API (Application Programming Interface).

In one example, the following information may be available at the NPCP module 16 at a master network device in a ring topology containing five slave network devices:
Master1>display NPCP Topology
   Topology: Ring
   Master0 port 0/1 Slave1 port 0/1
   Slave1 port 0/2 Slave2 port 0/1
   Slave2 port 0/2 Slave3 port 1/1
   Slave3 port 1/2 Slave4 port 0/1
   Slave4 port 0/2 Slave5 port 0/1
   Slave5 port 0/2 Master0 port 0/2 (secondary/blocked)
Master1>display NPCP Configuration brief
   Master° port 0/1 enabled
   Master° port 0/2 enabled (secondary/blocked)
   Slave1
   NPCP Node Name: Slave1
   NPCP ID: 1
   Operating System: version x.x.x
   NPCP port0/1 enabled
   NPCP port0/2 enabled
   Configuration version: X
   Slave2
   NPCP Node Name: Slave2
   NPCP ID: 2
   Operating System: version x.x.x
   NPCP port0/1 enabled
   NPCP port0/2 enabled
   Configuration version: X
   Slave3
   NPCP Node Name: Slave3
   NPCP ID: 3
   Operating System: version x.x.x
   NPCP port0/1 enabled
   NPCP port0/2 enabled
   Configuration version: X
   Slave4
   NPCP Node Name: Slave4
   NPCP ID: 4
   Operating System: version x.x.x
   NPCP port0/1 enabled
   NPCP port0/2 enabled
   Configuration version: X
   Slave5
   NPCP Node Name: Slave5
   NPCP ID: 5
   Operating System: version x.x.x
   NPCP port0/1 enabled
   NPCP port0/2 enabled
   Configuration version: X

An example of an NPCP table is shown in Table I below. The table includes node ID, node name, OS version, configuration version, and port information. It is to be understood that the table and data contained within the table are only examples, and that different data structures or data may be used.

TABLE I

| | Node | Node | OS | Configuration | | | | | | | |
|---|---|---|---|---|---|---|---|---|---|---|---|
| | Id | Name | Version | Version | Port | Port | Port | Port | Port | . . . | Port |
| Master | 0 | Master0 | x.x.x | X | 0/1 | | | | | | |
| Slave | 1 | Slave1 | x.x.x | X | 0/1 | 0/2 | | | | | |
| Slave | 2 | Slave2 | x.x.x | X | | 0/1 | 0/2 | | | | |
| Slave | 3 | Slave3 | x.x.x | X | | | 0/1 | 0/2 | | | |
| Slave | 4 | Slave4 | x.x.x | X | | | | 0/1 | 0/2 | | |
| Slave | 5 | Slave5 | x.x.x | X | | | | | 0/1 | | 0/2 |
| . | | | | | | | | | | | |
| . | | | | | | | | | | | |
| . | | | | | | | | | | | |
| Master | 0 | Master0 | x.x.x | X | | | | | | | 0/2 |

Logic may be encoded in one or more tangible non-transitory computer readable media for execution by the processor 22. For example, the processor 22 may execute codes stored in a computer-readable medium such as memory 24. The computer-readable medium may be, for example, electronic (e.g., RAM (random access memory), ROM (read-only memory), EPROM (erasable programmable read-only memory)), magnetic, optical (e.g., CD, DVD), electromagnetic, semiconductor technology, or any other suitable medium.

The interfaces 26 may comprise any number of interfaces (linecards, ports) for receiving data or transmitting data to other devices. The interface 22 may include, for example, an Ethernet interface for connection to a computer or network

The network device 20 may further include any suitable combination of hardware, software, algorithms, processors, devices, components, or elements operable to facilitate the capabilities described herein.

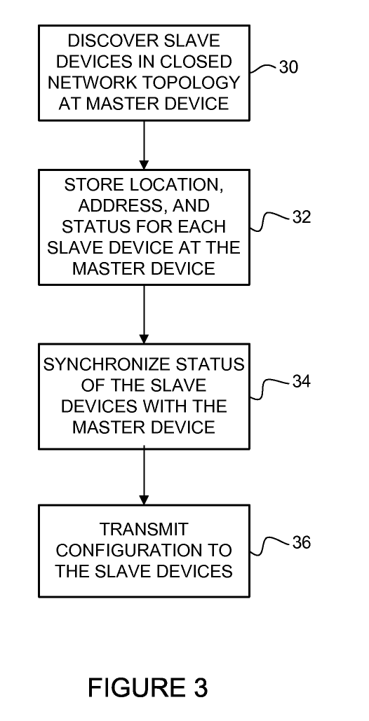

FIG. 3 is a flowchart illustrating an overview of a process for automated network configuration in a closed network topology, in accordance with one embodiment. At step 30, the master network device 10 discovers a plurality of slave network devices 12 in the closed network topology. Discovery may be performed, for example, when a new master 10 or slave 12 is installed in the network. In one example, the discovery process may be triggered at the master device 10 upon completion of a downstream port up status. Discovery may include, for example, identifying the slave devices 12 and the location of each of the slave devices in a specific network segment of the closed network topology. The master device 10 stores the location, address (e.g., MAC (Media Access Control) address or other identifier), and status (e.g., operating system, NPCP status) for each of the slave devices 12 (step 32). The status of each of the slave devices 12 is synchronized with the master device 10 (step 34). As described below, this may include verifying that the correct operating system is installed and running on each of the slave devices 12. After the network topology is identified and the status is synchronized at each of the slave devices 12, the master device 10 transmits a configuration (e.g., one or more configuration files) for application on each of the slave devices (step 36).

It is to be understood that the process illustrated in FIG. 3 is only an example and steps may be added, modified, deleted, or combined, without departing from the scope of the embodiments.

FIGS. 4-6 illustrate an NPCP process, in accordance with one embodiment. In the example shown in FIG. 4, the master device 10 is in communication with two slave devices (slave-1, slave-2) in a ring configuration (e.g., FIG. 1A). In this example, the master device 10 discovers a new installation. The master 10 stores all pertinent data in a master configuration file including location (e.g., device position numbers), addresses, and OS (operating system) versions. NPCP packet generation by the master 10 may be is triggered by completion of downstream port up status. For example, the master 10 may detect link up on the NPCP port (indicated at 41 in FIG. 4) and transmit an NPCP packet to slave-1 (42). Slave-1 receives the NPCP packet from the master 10 and designates the port receiving the packet as NPCP upstream.

In one example, slave-1 increments the first two bytes of the payload from 0000 0000 0000 0000 to 0000 0000 0000 0001 and transmits the packet to the next slave 12 in the chain (slave-2 in FIG. 4) (43). The transmit port at slave-1 is designated as NPCP downstream. Slave-1 may also transmit a return packet back to the master including 0000 0000 0000 0001, and specifying the MAC address, and status (e.g., NPCP status and version of operating system) at slave-1 (44). Slave-2 receives the NPCP packet and designates the port receiving the packet as NPCP upstream. Slave-2 may increment the first two bytes of the payload from 0000 0000 0000 0000 to 0000 0000 0000 0010 and transmit the packet to the next slave device in the chain (if there is another slave device in ring), designating transmit port as NPCP downstream. Slave-2 may transmit the packet back to the master including 0000 0000 0000 0010, switch MAC address, NPCP status, and version of operating system at slave-2 (45).

The above process continues until all slave devices 12 have been discovered (46). For example, a slave-3 device (not shown) may receive NPCP packet from the master 10 and designate the port receiving the packet as an NPCP upstream. Slave-3 may then increment the first two bytes of the payload from 0000 0000 0000 0000 to 0000 0000 0000 0011 and transmit the packet to the next slave in the chain, designating transmit port as NPCP downstream. Slave-3 may also transmit the packet back to the master 10 including 0000 0000 0000 0011, MAC address, NPCP status, and version of operating system. This continues for each slave device (e.g., slave-x). For example, slave-X receives NPCP packet from the master 10 and designates port receiving packet as NPCP upstream. Slave-X may then increment the first two bytes of the payload from 0000 0000 0000 0000 to 0000 0000 xxxx xxxx and transmit the packet to the next slave device 12 in the chain, designating transmit port as NPCP downstream. Slave-x may also transmit the packet back to the master including 0000 0000 xxxx xxxx, MAC Address, NPCP status, and version of operating system. If this is the last slave device 12 in the chain, the slave may add an additional ffff ffff byte to the payload after the operating system version.

If the master and slave devices 10, 12 are in a star topology, the NPCP packets will be sent directly between the master and each of the slave devices. In the case of a linear topology, return packets will be sent on a return path back to the master device 10.

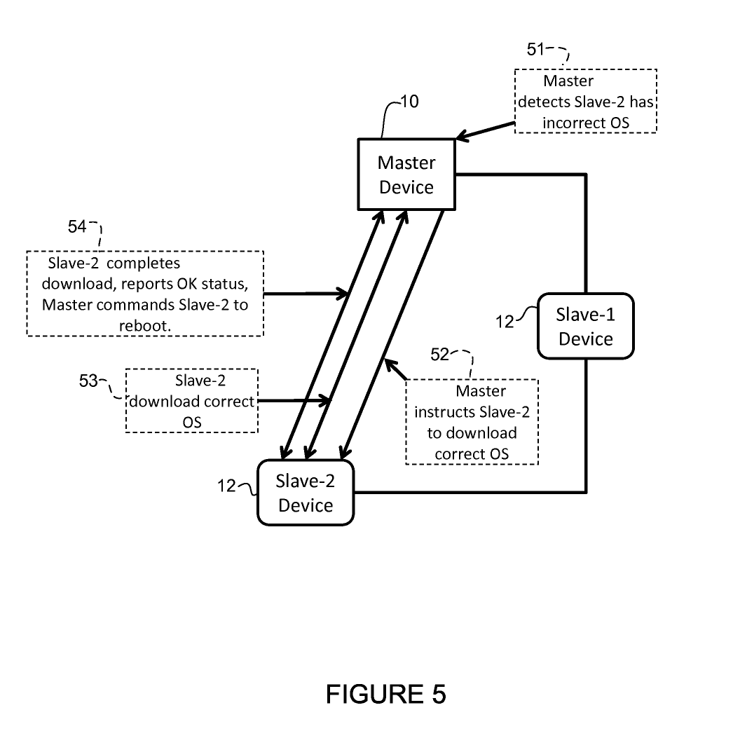

FIG. 5 illustrates an operating system synchronization process in accordance with one embodiment. As previously described, the master device 10 may validate all of the slave devices' operating systems against a current operating system on the master 10. Any discrepancies are noted and affected slave devices 12 may be instructed to request an operating system update. For example, as shown in FIG. 5, the master 10 has detected that slave-2 has an incorrect version of the operating system (51). The master 10 instructs slave-2 to download the correct version of the operating system (52). Slave-2 downloads the correct version of the operating system from the master (53). After slave-2 has completed download of the operating system, slave-2 notifies the master of completion (54). When the master 10 has been notified that all slaves 12 have the proper operating system downloaded, the master notifies affected slave devices (e.g., slave-2 in FIG. 5) to reboot on updated version of the operating system.

After reload, the master device 10 may notify all slave devices 12 to reset to factory default mode and reload. After all affected slave devices 12 have reported a successful second reload; the master 10 may initiate a unicast message to each slave device signaling the slave to request its associated configuration. After all slave devices 12 have notified the master 10 of successful configuration download and application, the master sets topology to active. All slave devices 12 set NPCP status to up, configuration status 1, for example. After receiving configuration from the master 10, the slave may set NPCP configuration status to up (0001). The slave devices 12 may then transmit NPCP status to the master 10 indicating operational up status and the slaves may begin transmitting NPCP topology health messages back to the master 10.

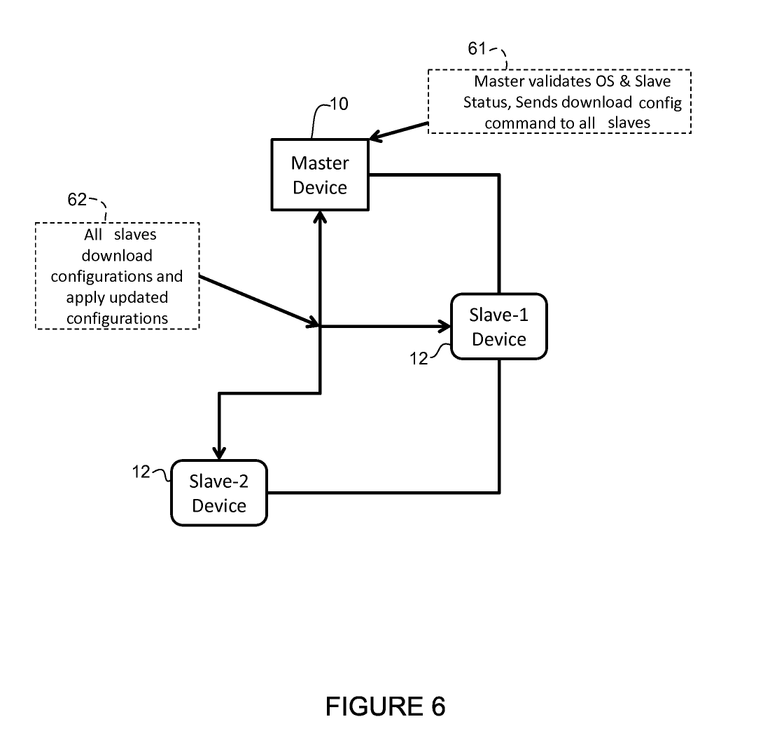

FIG. 6 illustrates an overview of a new installation distribution of configurations, in accordance with one embodiment. The master 10 validates OS and slave status, and sends download configuration command to all of the slave devices 12 (61). All slaves 12 download configurations and apply updated configurations (62).

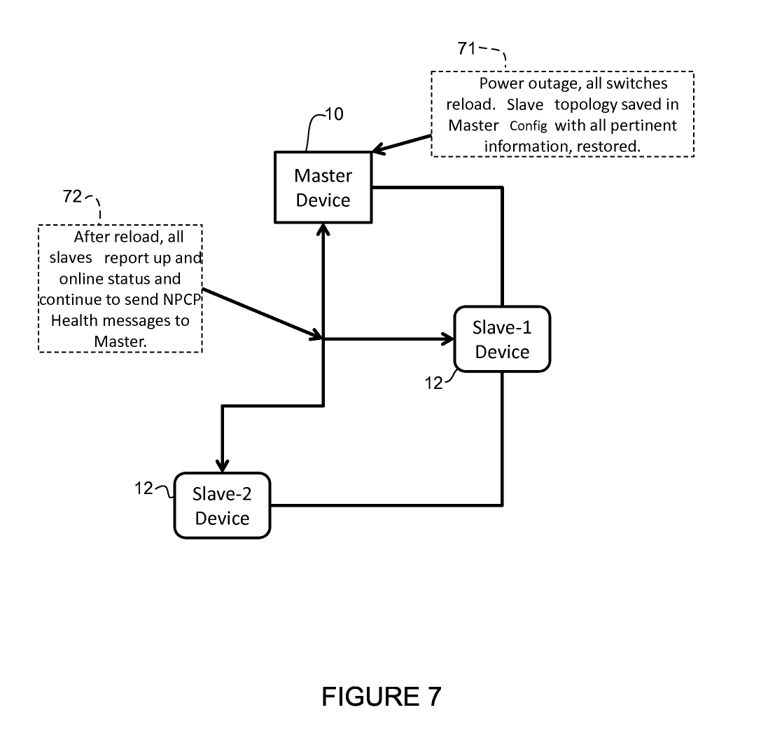

FIG. 7 illustrates power outage recovery, in accordance with one embodiment. All slave devices 12 reload and the master 10 restores topology and pertinent data from a stored configuration (71). After reload, all slave devices 12 may utilize an onboard saved configuration and report status as up and operational. The master 10 preferably reruns the discovery process to validate NPCP topology (72). The network is then recovered and slave devices 12 can send health messages to the master 10.

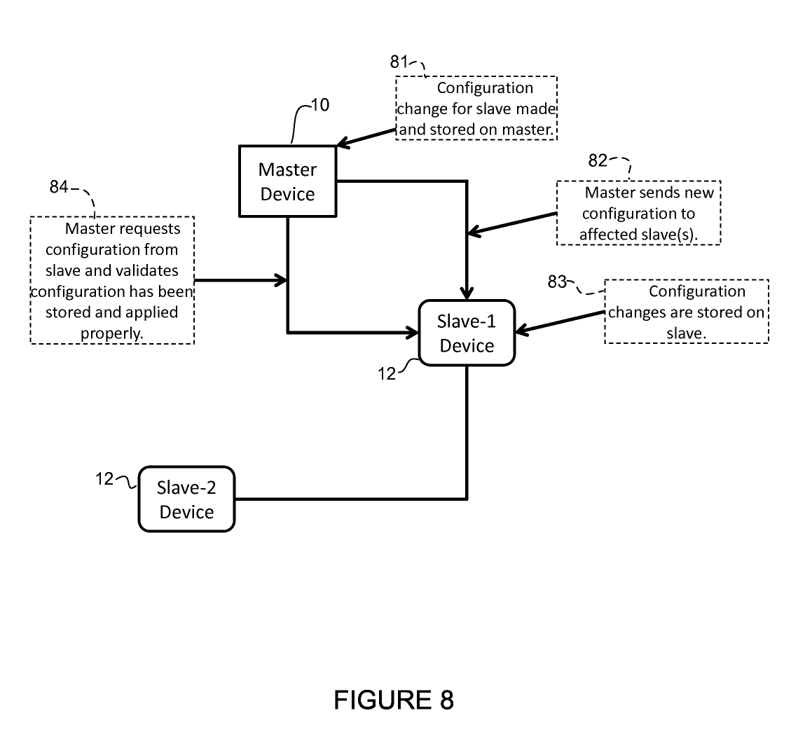

FIG. 8 illustrates a configuration change to slave-1 on the master device 10, in accordance with one embodiment. The slave-1 configuration change is stored on the master 10 (81). In one example, the operator may apply configuration changes in one of the three ways: (a) send configuration updates immediately; (b) send configuration updates on next reboot; or (c) send configuration updates at specific date and time. The master 10 distributes the new configurations to slave-1 (82) and changes are stored at slave-1 (83). The master 10 may request the configuration from slave-1 and validate that the configuration has been stored and applied properly (84).

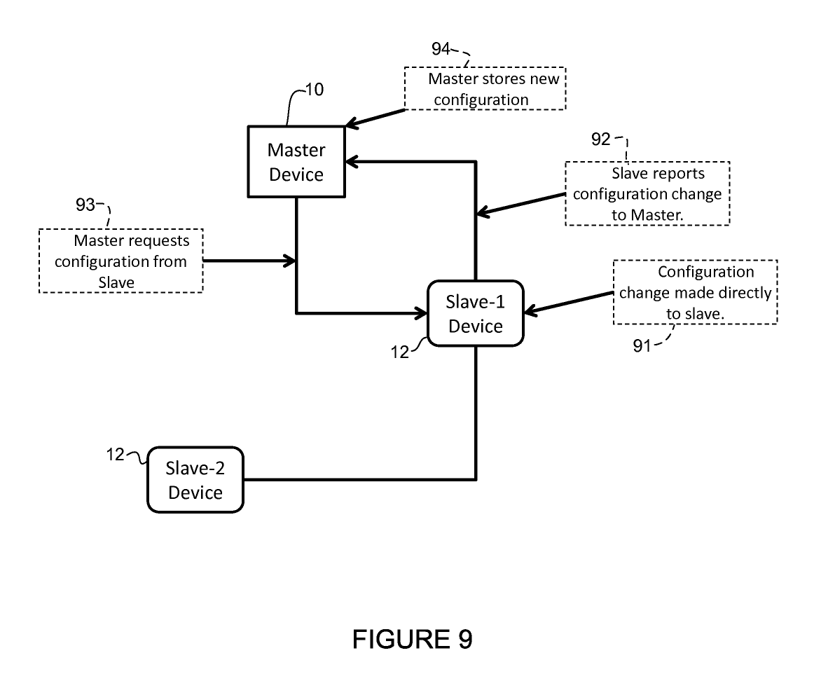

FIG. 9 illustrates a configuration change made directly on slave-1, in accordance with one embodiment. Slave-1 configuration changes are stored on slave-1 (91). Upon saving the configuration change, slave-1 notifies the master 10 of the configuration change (92). The master requests slave-1's new configuration (93). Slave-1 transmits the configuration to the master 10 and the master replaces slave-1's configuration in the master configuration table (94).

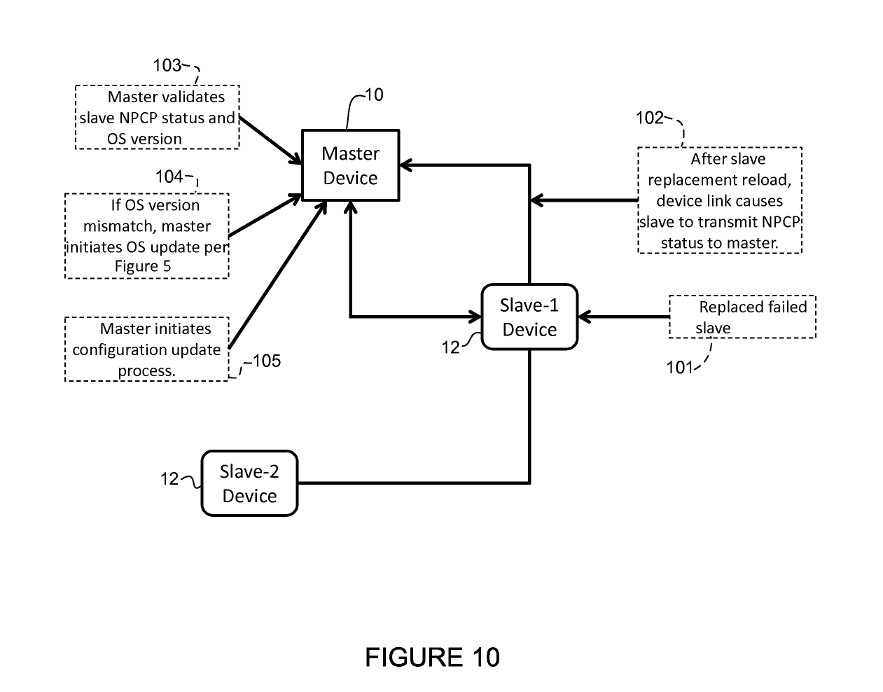

FIG. 10 illustrates a failed slave device replacement process, in accordance with one embodiment. Replacement of the failed device may be triggered by report of a downstream NPCP port down or the master failing to receive NPCP health message from slave-1. In this example, slave-1 is replaced (101). The new slave is installed in the network and transmits an NPCP status message to the master 10 on its upstream port (102). The master 10 may rerun the discovery process to validate NPCP topology and status (103). The master 10 may transmit a factory reset and reboot to slave-1. After reboot, the master 10 validates operating system and updates if needed (as described above with respect to FIG. 5) (104). The master 10 may then initiate a configuration update process (105). After configuration is complete, slave-1 can begin to transmit NPCP topology health messages back to the master 10.

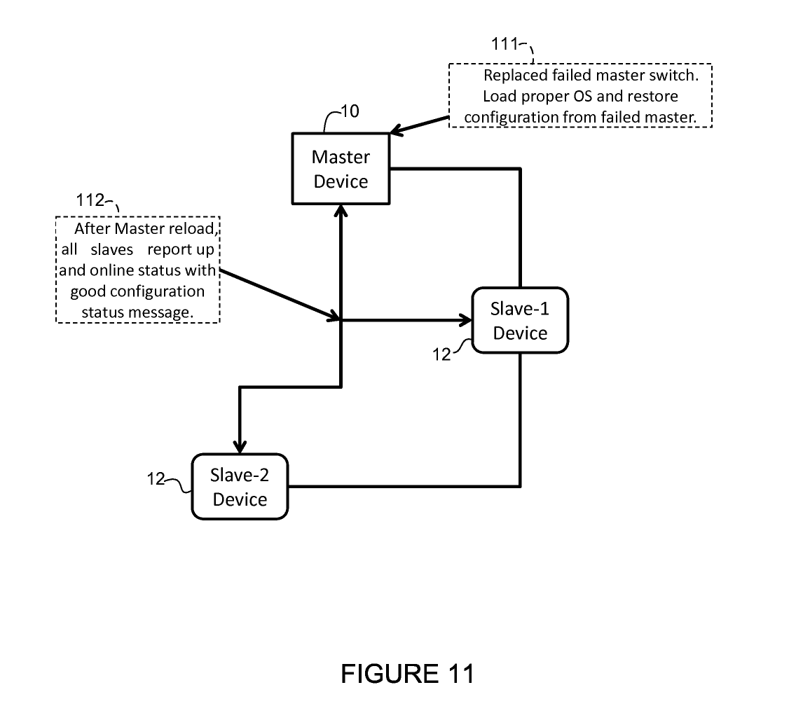

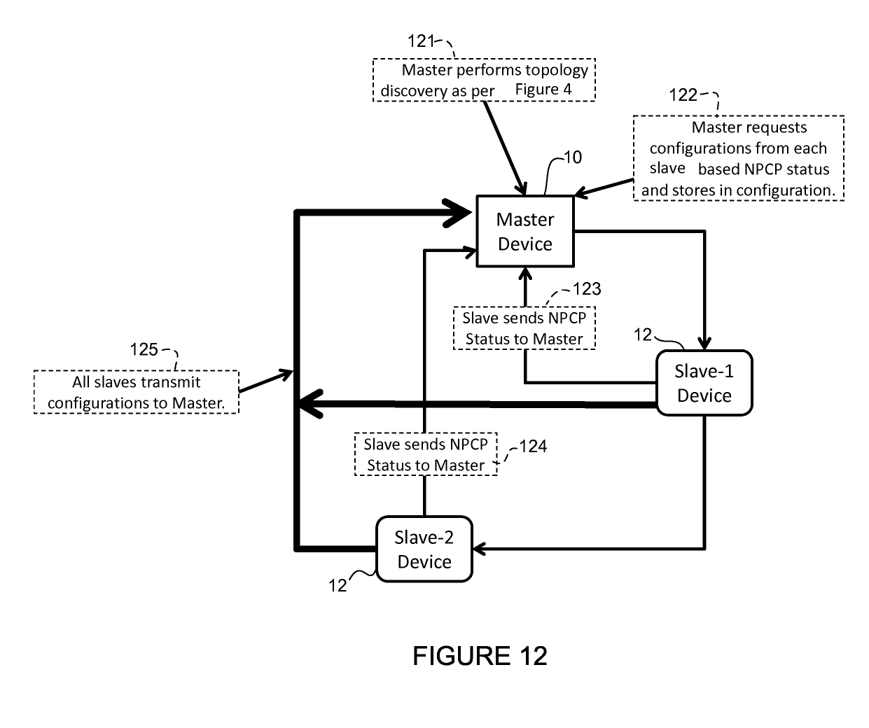

FIGS. 11 and 12 illustrate replacement of the master device 10. In the example of FIG. 11, the configuration is available from the failed master (e.g., primary master provided configuration to secondary master before failure). In the example of FIG. 12, there is no topology configuration available on the new master device 10.

Referring first to FIG. 11, a manual process is used to install the master 10 with a proper version of operating system. The master utilizes a configuration saved from the original master for topology and slave configurations (111). The new master 10 may be, for example, a backup (secondary) master already in place in the network. The master 10 may rerun the discovery process to validate NPCP topology (112).

Referring now to FIG. 12, the master 10 is installed with a proper version of operating system but no topology configuration. The master 10 performs topology discovery and receives configurations from slave devices 12 (121). The master may rerun the discovery process to validate the NPCP topology. For example, the master 10 may request a configuration from each slave device 12 based on NPCP status and store in its configuration table (122). The slaves 12 send NPCP status to master (123 and 124) and transmit configurations to the master 10 (125).

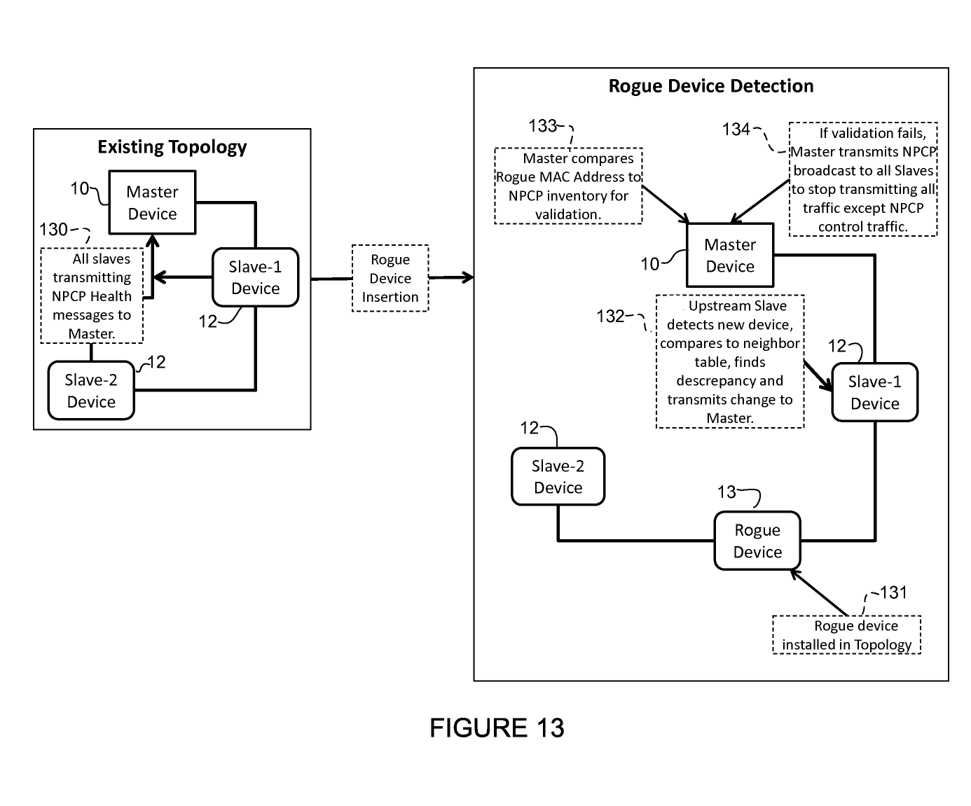

FIG. 13 illustrates rogue network device detection, in accordance with one embodiment. In an industrial Ethernet environment, where safety is critical, protection against rogue devices installed in the network topology is an important function. In certain embodiments, NPCP provides the capability to stop operation of the network upon detection of a rogue device in the topology. As previously described, all slave devices 12 may transmit NPCP health messages to the master 10 (130). Upon breakage of the topology, when a rogue device 13 is installed (131), affected slave devices 12 transmit NPCP health messages to the master device 10. When the link is restored from breakage, affected upstream slave-1 may compare the MAC address of the neighbor device to an NPCP table at the slave device (132). If the address has changed, slave-1 transmits a message to the master 10 identifying the new neighbor address.

The master 10 compares the received address to current NPCP inventory (133). If the address is not contained in inventory and there is no new slave configuration added to the master configuration, the master may transmit an NPCP broadcast to all slaves 12 to shutdown traffic forwarding for all traffic except NPCP control traffic (134).

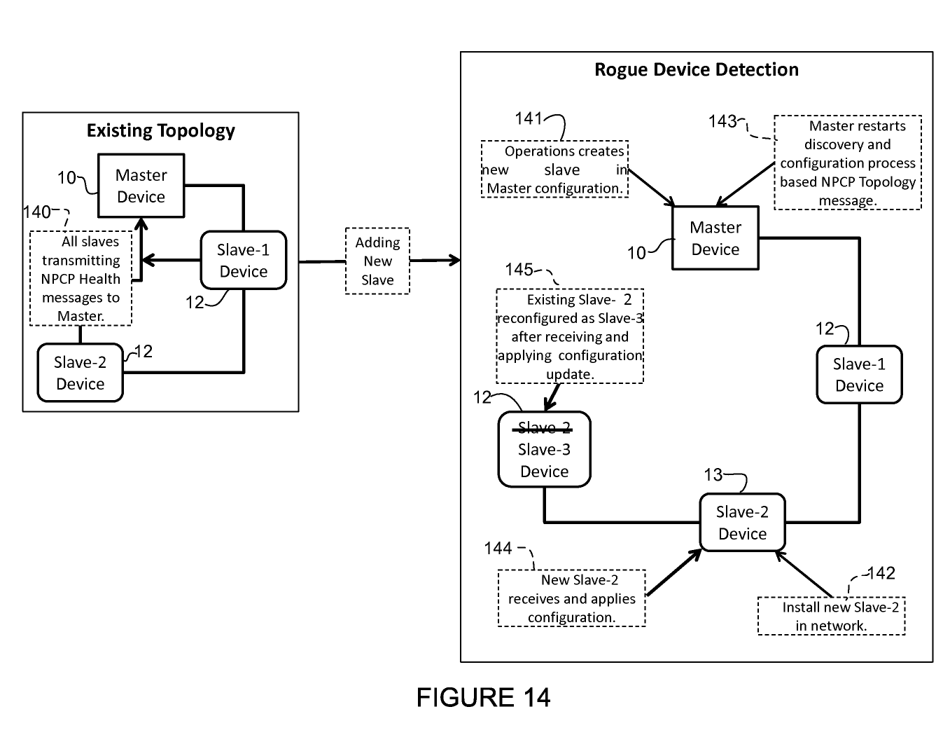

FIG. 14 illustrates addition of a new slave 12 to the network topology. As previously described, all slaves may transmit NPCP health messages to the master device 10 (140). When adding a new slave device 12 to the topology, the initial configuration is performed on the master 10 before inclusion into the topology (141). A new slave configuration is created on the master 10, by inserting new slave device-2 in the configuration, utilizing a newly created ring position. New slave-2 is then installed in the network (142). The master 10 may restart discovery and configuration process based on an NPCP topology change message (143). New slave-2 receives and applies its configuration (144). The system may automatically renumber existing slave devices 12 when the new slave is added in the topology. In the example shown in FIG. 14, the existing slave (previously slave-2) is reconfigured as slave-3 after receiving and applying the configuration update (145). When discovery and configuration process is complete, the new slave-2 will have been added and will begin transmitting NPCP topology health messages back to the master 10.

If new slave-2 is not created on the master 10 before installation, installation will result in triggering rogue slave detection and taking the network offline (as described above with respect to FIG. 13).

It is to be understood that the processes shown in FIGS. 4-14 and described above are only examples and that changes may be made without departing from the scope of the embodiments.

Although the method and apparatus have been described in accordance with the embodiments shown, one of ordinary skill in the art will readily recognize that there could be variations made without departing from the scope of the embodiments. Accordingly, it is intended that all matter contained in the above description and shown in the accompanying drawings shall be interpreted as illustrative and not in a limiting sense.

What is claimed is:

1. A method comprising:
discovering at a master network device, a plurality of slave network devices and locations of the slave network devices in a closed network topology;
storing at the master network device, a location, address, and status for each of the slave network devices;
synchronizing said status of each of the slave network devices at the master network device; and
transmitting from the master network device, a configuration for application at each of the slave network devices.

2. The method of claim 1 wherein said status comprises an operating system at the slave network device and wherein synchronizing said status comprises validating an operating system at the slave network device.

3. The method of claim 2 further comprising transmitting from the master network device, a new version of the operating system to the slave network device if the operating system is not validated.

4. The method of claim 1 wherein discovering further comprises exchanging network position control protocol packets with the slave network devices, said status comprising a network position control protocol status.

5. The method of claim 1 further comprising receiving at the master network device, periodic health messages from the slave network devices.

6. The method of claim 1 further comprising transmitting a change in configuration to one of the slave network devices.

7. The method of claim 1 further comprising receiving at the master network device, a new configuration from one of the slave network devices.

8. The method of claim 1 further comprising receiving at the master network device, a status change from one of the slave network devices, validating the slave network device, and transmitting a configuration update to the slave network device.

9. The method of claim 1 further comprising receiving an address for a new network device at the master network device and transmitting a message to all of the slave network devices to stop transmitting traffic if validation of the new network device address fails.

10. The method of claim 1 further comprising creating a new slave network device entry at the master network device and updating slave network device location numbers to the closed network topology.

11. An apparatus comprising:
a processor for processing a packet received from a master network device at a slave network device in a closed network topology comprising a plurality of slave network devices, transmitting a return packet to the master network device, the return packet comprising a location of the slave network device in the closed network topology, receiving a configuration from the master network device, and applying said configuration received from the master network device at the slave network device; and
memory for storing said configuration.

12. The apparatus of claim 11 wherein the processor is further operable to synchronize an operating system with and the master network device.

13. The apparatus of claim 11 wherein the processor is further operable to exchange network position control protocol packets with the master network device.

14. The apparatus of claim 11 wherein the processor is further operable to transmit periodic health messages to the master network device.

15. The apparatus of claim 11 wherein the processor is further operable to transmit a configuration change at the slave network device to the master network device.

16. The apparatus of claim 11 wherein the processor is further operable to receive an address for a neighbor slave network device and search for said address in a table of neighbor slave network device addresses.

17. The apparatus of claim 16 wherein the processor is further operable to transmit a message to the master network device if the received address is not found in the table.

18. The apparatus of claim 11 wherein the processor is operable to reconfigure a slave network device location upon receiving a configuration update from the master network device.

19. The apparatus of claim 11 wherein the processor is further operable to transmit a topology change message to the master network device if a change occurs at one of the ports of the slave network device.

20. Logic encoded on one or more non-transitory computer readable media for execution and when executed operable to:
discover at a master network device, a plurality of slave network devices and locations of the slave network devices in a closed network topology;
store at the master network device, a location, address, and status for each of the slave network devices;
synchronize said status of each of the slave network devices at the master network device; and
transmit from the master network device, a configuration for application at each of the slave network devices.
